(19) United States
(12) Patent Application Publication
(10) Pub. No.: US 2010/0211530 A1
(43) Pub. Date: Aug. 19, 2010

(54) SYSTEM AND METHOD FOR DISTRIBUTING EARNINGS

(76) Inventor: Yoshimi Tazawa, Tokyo (JP)

Correspondence Address: KANESAKA BERNER AND PARTNERS LLP, 1700 DIAGONAL RD, SUITE 310, ALEXANDRIA, VA, 22314-2848, US

(21) Appl. No.: 12/733,421

(22) PCT Filed: Nov. 21, 2007
(86) PCT No.: PCT/JP2007/073002

§ 371 Date: Mar. 1, 2010

(30) Foreign Application Priority Data
Aug. 27, 2007 (JP) 2007-246124

(51) Int. Cl. G06Q 90/00

(52) U.S. Cl. 705/500

(57) ABSTRACT

There is a demand for a profit distribution technique that provides an effective incentive for sale. When a bonus point is given for a successful sales result, a group update process is performed to cancel the location of the member in the first generation of the group and to form two groups, in each of which a member who has been in the second generation is set as a new first-generation member. One of the groups formed includes the member with ID number “1” as the first-generation member and the other includes the member with the ID number “2” as the first-generation member. In the group in which the member with ID number “1” is in the first generation, the members with ID numbers “3” and “4” that were the third-generation members before the update become the second-generation members.

This application claims benefit of Japanese Application No. 2007-246124 filed in Japan on Aug. 27, 2007, the contents of which are incorporated by this reference.

### FIELD OF THE INVENTION

The present invention relates to a system and method for distributing earnings, especially to a profit distribution system and a profit distribution method.

### BACKGROUND ART

A wide variety of distribution channels are available today. In the past, commodities were typically distributed from a manufacturer to wholesalers to retailers. It is no exaggeration to say that whether a commodity was going to sell well or not or going to be a hit depended on a choice of a distribution channel or on whether an advertisement effectively appeals to audience or not.

However, another process is boosting sales of commodities in these days. The so-called “word of mouth” sometimes spreads positive messages about a commodity among users, thereby dramatically increasing sales of the commodity.

While word of mouth has occasionally boosted sales of commodities, it has often been nothing more than a temporary phenomenon. Although users may know the commodity is good, they may content themselves with a substituting commodity when the commodity is not available at the next timing of purchase. If that is the case, the commodity can fade into oblivion.

To prevent this situation, there is a marketing method that introduces a bonus system in which bonuses are paid to users or dealers according to their sales figures to give an incentive to sell commodities. The bonus system is adopted by many businesses such as cellular phone and car dealers.

There is another system in which dealers are listed in order of registration and the sales result of a dealer registered later is reflected in the sales result of a dealer registered earlier. In this system, when the number of registered dealers at an intermediate stage exceeds a certain value, a shortage of assets for bonuses can be caused, resulting in collapse of the system. A technique has been proposed in which a certain percentage of the aggregate amount of sales is set as the assets for bonuses in advance and bonuses are distributed to dealers according to their sales results in order to avoid collapse of such a system.

### DISCLOSURE OF THE INVENTION

### Problems to be Solved by the Invention

In the technique disclosed in JP2005-4309A, the dealers cannot know the amounts of their own bonuses until the timing of calculation of the bonuses. Furthermore, if the sales of a particular dealer have increased but the overall sales have not, the amounts of bonuses can be small. Accordingly, there is a problem that it is difficult to give an incentive for dealers to sell commodities.

The present invention has been made in light of these circumstances and an object of the present invention is to provide a profit distribution technique that provides an effective incentive for sale.

### Means for Solving the Problems

An aspect of the present invention relates to a profit distribution system. The profit distribution system includes: an identification number assigning means assigning an identification number to each of customers to be registered as members in connection with purchase of a predetermined commodity as a part of information about the members in order of registration; member positioning means for associating and positioning two members with each member as members at the next level below the member; group forming means for forming one group having first to n^{th} levels (where n is a natural number) and comprising a quorum of 2ⁿ−1 members; point giving means for giving a predetermined point to a member at the first level of the group as a right to receive a bonus when 2ⁿ-1 members belong to the group and the quorum has been reached; group updating means for, when a point is given by the point giving means, canceling the location of the member at the first level and dividing the group to which the member at the first level has belonged into two to form two new groups, each having as the member at the top level a member that has been at the second level of the group to which the member at the first level has belonged; and bonus determining means for determining a bonus to be paid to a member according to a point given by the point giving means.

The group updating means may assign two identification numbers to the member whose location at the first level has been canceled and reposition the member in two locations next to the last registered member.

Another aspect of the present invention relates to a profit distribution method. The method includes: an identification number assigning step of assigning an identification number to each of customers to be registered as members in connection with purchase of a predetermined commodity as a part of information about the members in order of registration; a member positioning step of associating and positioning two members with each member as members at the next level below the member; a group forming step of forming one group having first to n^{th} levels (where n is a natural number) and comprising a quorum of 2ⁿ−1 members; a point giving step of giving a predetermined point to a member at the first level of the group as a right to receive a bonus when 2ⁿ-1 members belong to the group and the quorum has been reached; a group updating step of, after a point is given by the point giving step, canceling the location of the member at the first level and dividing the group to which the member at the first level has belonged into two to form two new groups, each having as the member at the top level a member that has been at the second level of the group to which the member at the first level has belonged; a bonus determining step of determining a bonus to be paid to a member according to a point given by the point giving means; and a payment indicating step of indicating that a bonus determined in the bonus determining step is to be paid.

The group updating step may assign two identification numbers to the member whose location at the first level has been canceled and reposition the member, in two locations next to the last registered member.

### ADVANTAGES OF THE INVENTION

According to the present invention, a profit distribution technique that gives an effective incentive for sale can be provided.

### DETAILED DESCRIPTION OF THE PREFERRED EMBODIMENTS

In an embodiment, a system is proposed that accumulates a portion of sales for each individual registered member each time the member makes a repeat purchase of a commodity every month to allow the member to receive an accumulated-dividend-type bonus. In order to allow all subscribers to receive their bonuses on an equitable basis, an upper limit is set so that all subscribers can be rewarded. The system can be operated by relying only on repeated purchases by existing subscribers even if new subscribers are not recruited since a mutual-aid relationship among the subscribers is established.

The system as a whole adopts a sales membership system having a pyramid structure. This type of membership system is commonly known as the MLM (Multi-Level Marketing) system. Many membership systems having a pyramid structure use a mechanism in which compensation paid to upper-level members increases as the number of lower-level members increases. Accordingly, only members who subscribed in an early stage can practically receive bonuses. Therefore the system has tended to collapse. The system of the present embodiment can solve the problem.

In order to prevent such a collapse, the present embodiment places a restriction on the hierarchical structure. Specifically, three-layer structure (system) of the first to third layers is provided in which two members are placed below one member. When the total number of members in the structure reaches seven, the member at the first level, which is the topmost level, is given the right to receive a bonus. After a bonus is paid, the hierarchical structure is updated to promote the members at the second and third levels to the level immediately above. The embodiment will be described below in detail.

FIG. 1 is a functional block diagram of a business transaction management system 10 according to the present embodiment. The business transaction management system 10 includes a management unit 20, an input/output controller 30, an internal storage 32, an input unit 40, and an output unit 50. The components of the business transaction management system 10 can be implemented by integrated circuits such as a CPU (Central Processing Unit) and a memory and a given program loaded into the memory. Functional components typically included in a computer, such as CPU, RAM, ROM, etc. are not shown in FIG. 1.

The input/output controller 30 centrally controls instructions issued by a user who is a business administrator to the business transaction management system 10, display outputs and print outputs presented to the user, recording of data and others.

The input unit 40 obtains a user operation performed on input means 41 such as a keyboard and a mouse and outputs the user operation to the input/output controller 30. The output section 50 includes a display output section 51 which generates and outputs data to be displayed on a display monitor 53, a print output section 52 which outputs data to be printed on forms or the like on a printer 54, and a data output section 55.

The management unit 20 is formed by a program including multiple functions, each for each item managed in the business transaction management system 10. Specifically, the management unit 20 includes a customer management section 21, a sales management section 22, a money receipt management section 23, a delivery management section 24, a bonus management section 25, and maintenance management section 26.

The internal storage 32 records data input in the business transaction management system 10. Input data may be recorded without processing or data processed by the functions of the management unit 20 may be stored. Data may be temporarily stored in the internal storage 32 and deleted at a predetermined timing such as shutdown of the business transaction management system 10, or may remain recorded until a delete operation is performed by the user.

FIG. 2 illustrates an exemplary initial screen displayed on the display monitor 53 when the business transaction management system 10 is started up. As illustrated, the six management items given above are selectably displayed. A user who is a customer administrator uses the input means 41 such as the keyboard or mouse to select a desired item to activate the function (program) associated with the selected item.

The customer management section 21 manages membership information about members as customers. Specifically, in response to a depression operation of the “Customer management” button 61 on the screen in FIG. 2, the input/output controller 30 activates the customer management section 21 and displays a “Customer management” menu on the display monitor 53 through the display output section 51. On the displayed “Customer management” menu, a business administrator can input data such as the member name, address, telephone number, registration date, shipping address, bank name, commodity data, and bonus payment date of a member as membership information, to store the data in the internal storage 32. In doing this, the customer management section 21 automatically assigns a customer ID to the registered member and manages the customer ID as part of the membership information.

The sales management section 22 performs order and sales processing of order placed by and sales made by members who are customers. Specifically, in response to a depression operation of the “Sales management” button 63 on the screen in FIG. 2, the input/output controller 30 activates the sales management section 22 and displays a “Sales management” menu on the display monitor 53 through the display output section 51. The user who is the business administrator performs an operation such as calculation of sales, filling in a sales slip, or printing a delivery slip on the displayed “Sales management” menu on the basis of data such as a customer ID, customer name, order date, and commodity data included in membership information. The “Sales management” button 63 causes the filled in sales data to be stored in addition to the membership information.

The money receipt management section 23 manages money receipt from members who are customers. Specifically, in response to a depression operation of the “Sales management” button 63 on the screen in FIG. 2, the input/output controller 30 activates the money receipt management section 23 and displays a “Money receipt management” menu on the display monitor 53 through the display output section 51. The user who is the business administrator inputs and manages money receipt from a member on the displayed “Money receipt management” menu on the basis of data such as the customer ID, customer name, and order date included in membership information. The data may be directly input by the user by using the input means 41 or may be read from data in a predetermined format recorded in an external storage 42 or an external recording medium. The money receipt management section 23 generates money receipt data such as the receipt date and received amount from the input data and records the receipt data in the internal storage 32 in addition to the membership information.

The delivery management section 24 performs delivery management. Specifically, in response to a depression operation of a “Delivery management” button 65 on the screen in FIG. 2, the input/output controller 30 activates the delivery management section 24 and displays a “Delivery Management” menu on the display monitor 53 through the display output section 51. The user who is the business administrator inputs a delivery date, fills in a delivery slip, and performs input operations for a shipping order to a delivery company on the basis of data such as the customer ID, name, address and phone number of a customer, the order date, and commodity data included in membership information on the displayed “Delivery management” menu. The delivery management section 24 generates delivery data and records the data in the internal storage 32 in addition to the membership information.

The bonus management section 25 manages bonuses of members who are customers. Specifically, in response to a depression operation of a “Bonus management” button 62 on the screen in FIG. 2, the input/output controller 30 activates the bonus management section 25 and displays a “Bonus management” menu on the display monitor 53 through the display output section 51. The user who is the business administrator instructs the bonus management section 25 to execute a bonus calculation process command, for example, on the displayed “Bonus management” menu. In response to the instruction, the bonus management section 25 determines on the basis of the data such as the customer ID and bonus payment date in the membership information whether a bonus is to be paid or not, calculates the bonus if so, and generates transfer data and records the data in the internal storage 32 in addition to the membership information.

The maintenance management section 26 has a menu-driven master maintenance management function of performing internal management and maintenance such as editing corporate information, commodity information; slips and bills and a menu-driven security control function of performing security operations such as data back up and password-protection of confidential data.

Data required for processing is exchanged among the programs (menus) of the customer management section 21, the sales management section 22, the money receipt management section 23, the delivery management section 24, the bonus management section 25 and the maintenance management section 26 and data newly generated by the programs is registered in membership information. The process is repeatedly executed to accomplish transaction processing.

An operation of the business transaction management system 10 having the configuration described above will be described below. FIG. 3 is a flowchart illustrating a transaction flow in the business transaction management system 10 according to the present embodiment.

The business administrator (user) confirms whether money has been received (transferred) or not on the basis of a bank transfer form attached to an order form sent from a customer (S10).

When the user confirmed the receipt of money, the user activates the customer management section 21 on the business transaction management system 10 to display the “Customer management” menu on the display monitor 53, and inputs membership information contained in the order form to register the customer as a member (S12). That is, the customer management section 21 obtains the membership information and records the membership information in the internal storage 32.

Then, the user activates the sales management section 22 on the business transaction management system 10 and instructs the sales management section 22 to calculate sales on the “Sales management” menu (S14).

The sales management section 22 then generates sales data on the basis of calculate sales (S16), generates a sales slip on the basis of instructions and settings made by the user as required (S18), and generates a shipping slip (S20). The sales slip and shipping slip generated are printed out on the printer 54 through the print output section 52.

Then the user activates the delivery management section 24 on the business transaction management system 10 to display the “Delivery management” menu and instructs the delivery management section 24 to generate delivery data. The delivery management section 24 generates delivery data in response to the instruction (S22). After the delivery data is generated, when the user operates a shipping order button (not shown) provided on the “Delivery management” menu or otherwise issues a delivery instruction on the “Delivery management” menu, the delivery management section 24 sends the generated delivery data to a delivery company undertaking commodity storage and delivery management through network communication means such as electronic mail to direct the delivery company to deliver the commodity to the member who is a customer (S24). When the delivery company receives the delivery direction, the delivery company delivers the commodity to the customer on the basis of the delivery data.

Then, the user who is the business administrator activates the bonus management section 25 on the business transaction management system 10 and instructs the bonus management section 25 to calculate the bonus for the member (S26). Details of the bonus mechanism and calculation will be described later.

After completion of the calculation of the bonus, the bonus management section 25 determines whether the bonus is to be paid or not (S28). If the bonus is not to be paid (N at S28), the process will end. If the bonus is to be paid (Y at S28), the bonus management section 25 calculates the amount of the bonus, generates bank transfer data, and outputs the data in a predetermined format on the printer 54 through the output unit 50 (S30).

The business administrator performs a procedure for transferring the bonus to the member on the basis of, the output transfer data (S32). The business transaction is performed through the process described above.

The mechanism and calculation of a bonus will be described below. FIG. 4 is a diagram illustrating the bonus mechanism according to the present embodiment. As illustrated, customer IDs (hereinafter sometimes referred to as “ID numbers”), which are sequential numbers in order of registration starting with “0”, are assigned to customers to be registered as members.

Always two members one generation below are associated and registered with each member (customer). For example, members with ID numbers “1” and “2” one generation below are associated and registered with the member with ID number “0” in FIG. 4. Members with ID numbers “3” and “4” one generation below are associated and registered with the member with ID number “1”. Likewise, members with ID numbers “5” and “6” one generation below are associated and registered with the member with ID number “2”.

In the present embodiment, three generations, in other words, three levels, make up one group. Specifically, one member is placed in the first generation (level), two members are placed in the second generation (level), and four members are placed in the third generation (level). In total seven members make up one group with a quorum of seven. The number of constituent generations of one group (levels) is not limited to three. For example, one group may be made up of five or eight levels. If one group is made up of five levels, the quorum of the group is 2⁵−1=31; if one group is made up of n levels, the quorum of the group is 2ⁿ−1.

In FIG. 4, when seven members are registered in one group and therefore the quorum is reached, a point that serves as a basis for calculating the bonus is given to the member with ID number “0” in the first generation. The group made up of seven members is also called “basic unit”.

FIG. 5 is a diagram illustrating a group update process performed after a point is given. After a point is given, the group update process is performed in which the location of the member in the first generation of the group is canceled and two groups are formed with the members in the second generation as the new first-generation members.

Specifically, one of the groups formed includes the member with ID number “1” as the first-generation member and the other includes the member with the ID number “2” as the first-generation member. In the group in which the member with ID member “1” is in the first generation, the members with ID numbers “3” and “4” that were the third-generation members before the update become the second-generation members. Likewise, in the group in which the member with ID number “2” is in the first generation, the members with ID numbers “5” and “6” that were the third-generation members before the update become the second-generation members.

Again, seven members belong to each of these groups. When the quorum of the group is reached, a point for a bonus is given, and the group update process is performed as described above.

The member that is in the first generation and given the point is repositioned next to the last member registered at the time the point is given. Furthermore, two new ID numbers are assigned in the repositioning. That is, the member is repositioned next to the last registered member as illustrated in FIG. 6. In the repositioning, two new ID numbers are assigned to the member. Specifically, if the ID number of the last registered member is “50”, ID numbers “51” and “52” are assigned as illustrated in FIG. 6. When a registered member has purchased a commodity the next time, new ID numbers are assigned.

A program that executes the process for giving a bonus described above will be described below with reference to FIGS. 7 through 9. The program language used is Microsoft Visual Basic (registered trademark). Here, a function named “Tamago” is used as a function constituting the program.

(1) First, membership information is registered on a dedicated input screen secured with original security (protected with a password) in accordance with an input form. A sequential ID number starting with “0” in order of registration is automatically assigned. This belongs to the “Customer management” menu. The membership information is registered in a table used for calculation of bonuses (hereinafter also referred to as the “Tamago table”) and processes are performed.

The following three processes are performed:

Process 1-1: The membership information is searched for a customer that has not been registered in the Tamago table (an item without a Tamago table registration date).

Process 1-2: Information required for bonus calculation (such as the customer ID and payment date) is extracted from the membership information of an unregistered customer found.

Process 1-3: The date on which the customer has been registered in the Tamago table is registered in the membership information.

The procedure enables a bonus to be calculated automatically.

(2) Then, determination is made as to whether or not a customer (member) registered in the Tamago table is eligible to receive a bonus. If the member of interest is at the top and the quorum of seven is reached, the member is considered to be eligible to receive a bonus and the point described above is given to the member. Therefore, the smallest ID number of the last registered member that is required for forming a basic unit (group) in which the member of interest is at the top (the first level/generation) is calculated.

A program (function) illustrated in FIG. 8 is a function for calculating the ID number (the last ID of the basic unit) that is equivalent to “6” when the ID number of the member of interest in the basic unit is “0” by using an equation “first ID two generations below member of interest+4×(ID number of member of interest−first ID in generation of member of interest+1)−1”.

As a preparation, the first and last ID numbers of each generation are calculated first. Then, the calculated ID numbers are substituted into the function given above. Thus, determination can be made as to whether the member is eligible to receive a bonus, regardless of which generation the member of interest belongs to.

A program (function) illustrated in FIG. 9 is a function used for obtaining for any given ID number the following values:

1) Case 0: The generation to which the ID number belongs

2) Case 1: The first ID number of the generation

3) Case 2: The first ID number of the generation that is two generations below

4) Case 3: The last ID number of the generation that is two generations below

The last ID number of the basic unit thus obtained can be substituted into the function described below to compute whether the member of interest is eligible to receive a bonus.

A program (function) illustrated in FIG. 10 is a function used for computing that if the ID number of the last registered member is greater than or equal to the last ID number of the basic unit, then the member is eligible to receive a bonus, otherwise, the member is not eligible to receive the bonus. Using the functions described above, the members registered in the Tamago table that have not yet received a bonus are scanned in order of registration (ascending order of ID number) to determine whether the members are eligible to receive a bonus or not.

A program (function) illustrated in FIG. 11 selects an eligible member from among the members who have not yet received a bonus.

(3) Next, a payment date for the eligible member is set and two ID numbers of the eligible member are additionally registered next to the ID number of the last registered member. That is, two duplications of the member are formed.

A program (function) illustrated in FIG. 12 executes the following three processes:

Process 3-1: The payment date extracted in Process 1-2 in (1) is checked to determine whether the date is the current date and, if so, payment is set for the eligible member.

Process 3-2: A duplication of the ID number of the eligible member is registered next to the ID of the last registered member. The process is performed twice, thereby additionally registering two duplications (new ID numbers).

Process 3-3: The process is repeated until there is no further eligible member, and then the process will end. (The same process is repeated for newly added IDs.)

(4) Then, the amount of payment is calculated and is set. A program (function) illustrated in FIG. 13 executes the following three processes:

Process 4-1: The payment date set in (3) 3-1 is stored.

Process 4-2: The table is narrowed down by using that date and the number of cases on the payment date for each customer ID is calculated.

Process 4-3: The number of cases multiplied by 2000 yen is set as the amount of payment.

As a result, data for transferring bonuses is generated and the bonuses are paid to the eligible members on the basis of the data.

According to the present embodiment described above, a profit distribution technique that gives an effective incentive for sale can be provided. Furthermore, a program that automatically performs calculation of bonuses in the processes described in (1) through (4) can improve the efficiency of the transaction for paying bonuses to members.

The present invention has been described with respect to an embodiment thereof. It will be understood by those skilled in the art that the embodiment is illustrative and various variations of combinations of components and processes of the embodiment are possible and such variations also fall within the scope of the present invention.

### BRIEF DESCRIPTION OF THE DRAWINGS

FIG. 1 is a functional block diagram of a business transaction management system according to an embodiment;

FIG. 2 is a diagram illustrating an initial screen displayed on a display monitor when the business transaction management system is started up according to the present embodiment;

FIG. 3 is a flowchart of a workflow of the business transaction management system according to the present embodiment;

FIG. 4 is a diagram illustrating a basic unit for bonus payment according to the present embodiment;

FIG. 5 is a diagram illustrating basic units generated by group update processing performed after a point is given according to the present embodiment;

FIG. 6 is a diagram illustrating multiple basics units registered in the business transaction management system according to the present embodiment;

FIG. 7 is a diagram illustrating a program executing a process for paying a bonus according to the present embodiment;

FIG. 8 is a diagram illustrating a program executing a process for paying a bonus according to the present embodiment;

FIG. 9 is a diagram illustrating a program executing a process for paying a bonus according to the present embodiment;

FIG. 10 is a diagram illustrating a program executing a process for paying a bonus according to the present embodiment;

FIG. 11 is a diagram illustrating a program executing a process for paying a bonus according to the present embodiment;

FIG. 12 is a diagram illustrating a program executing a process for paying a bonus according to the present embodiment.

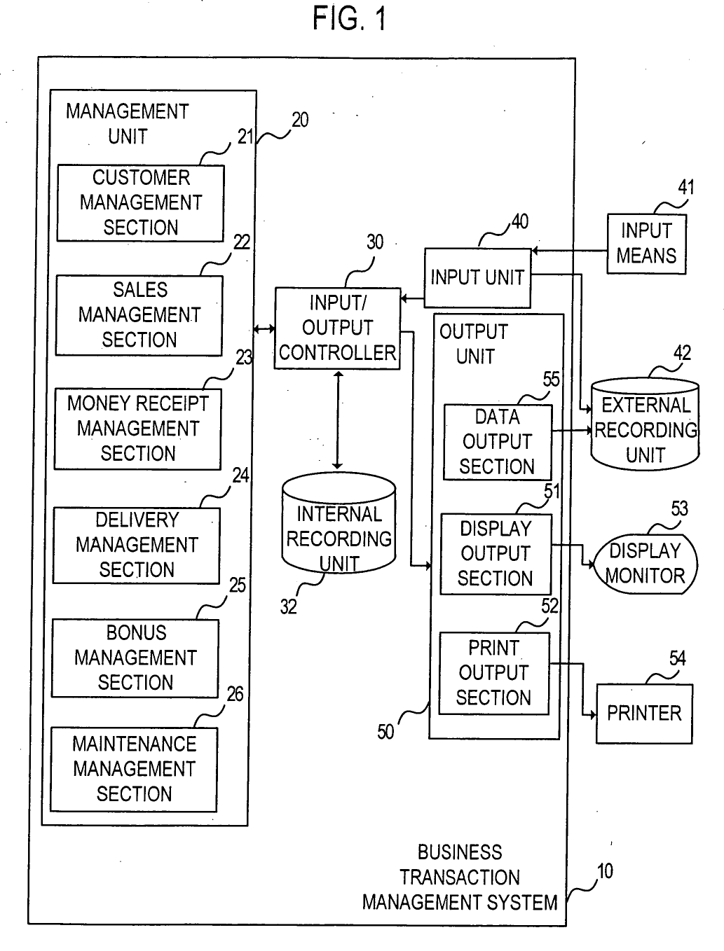

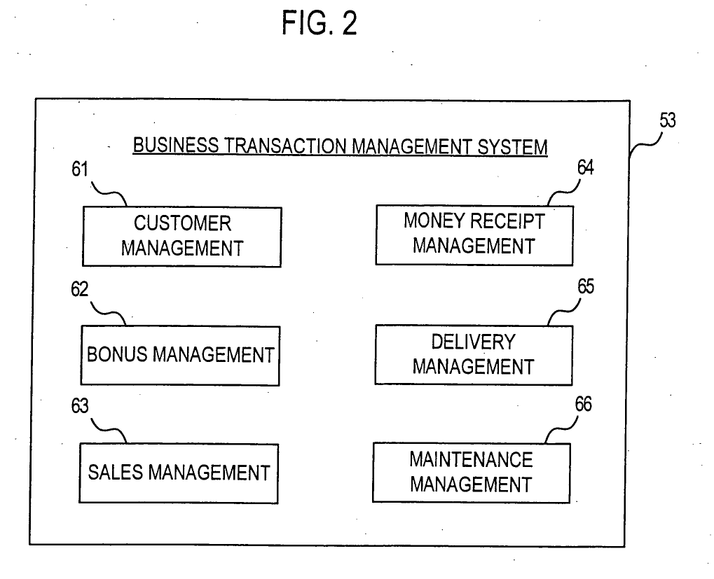

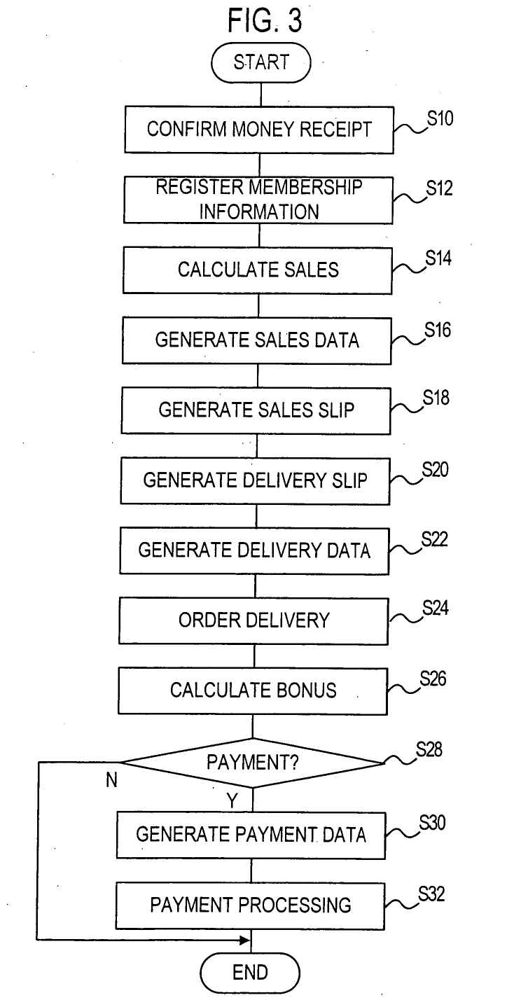

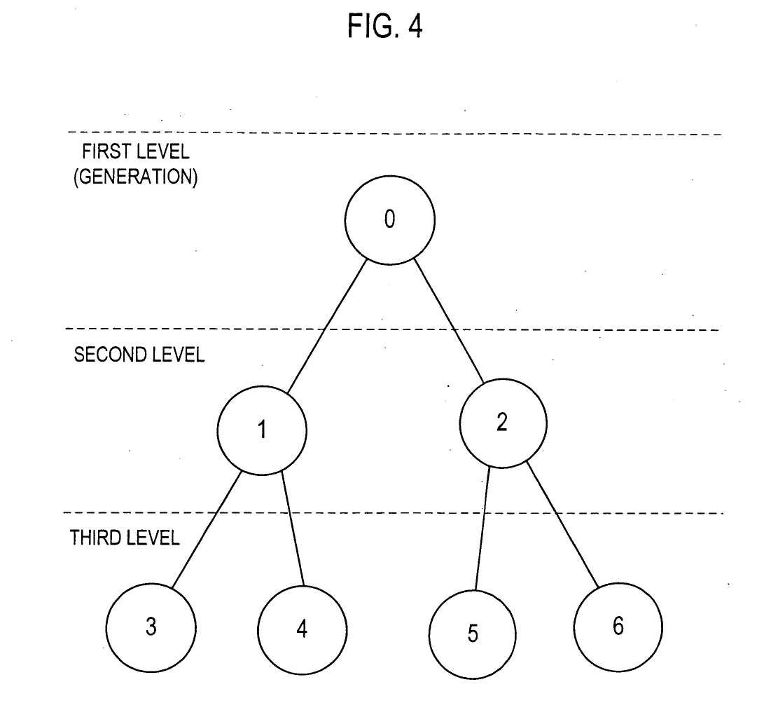

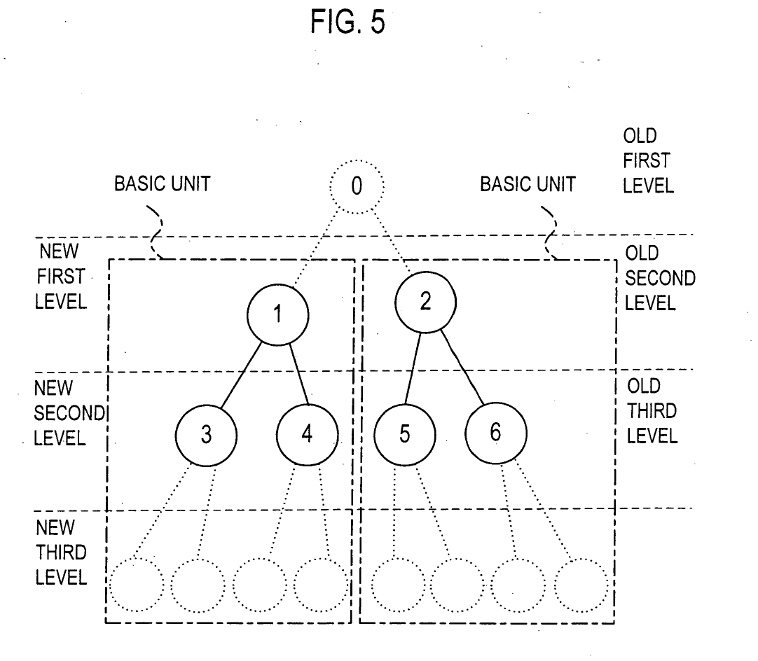

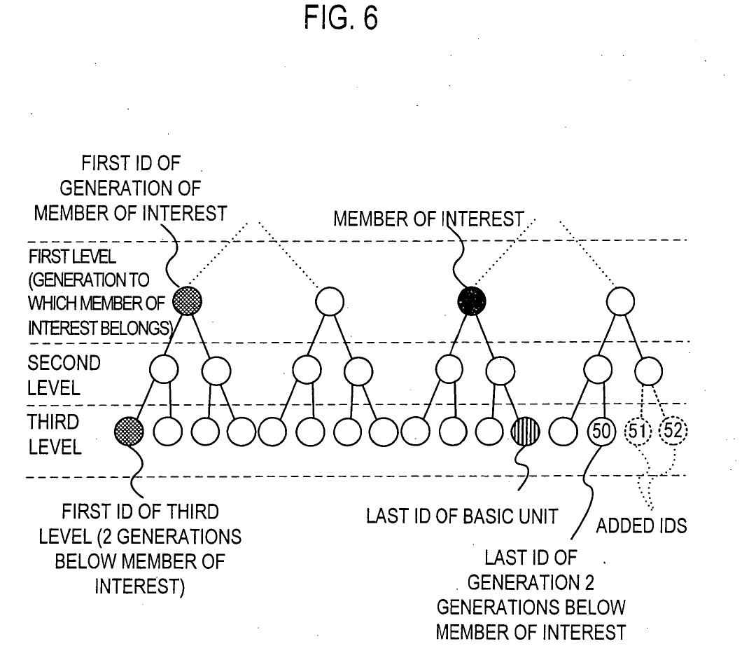

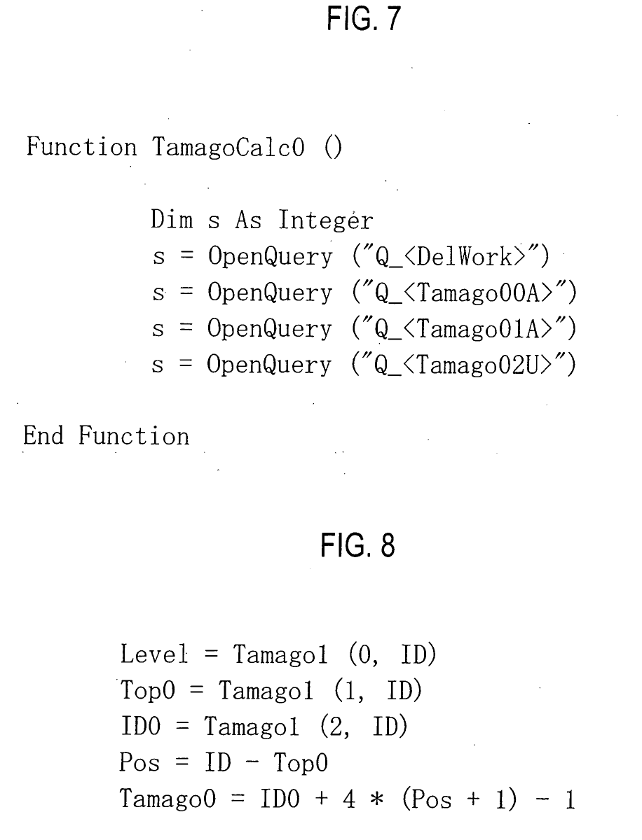

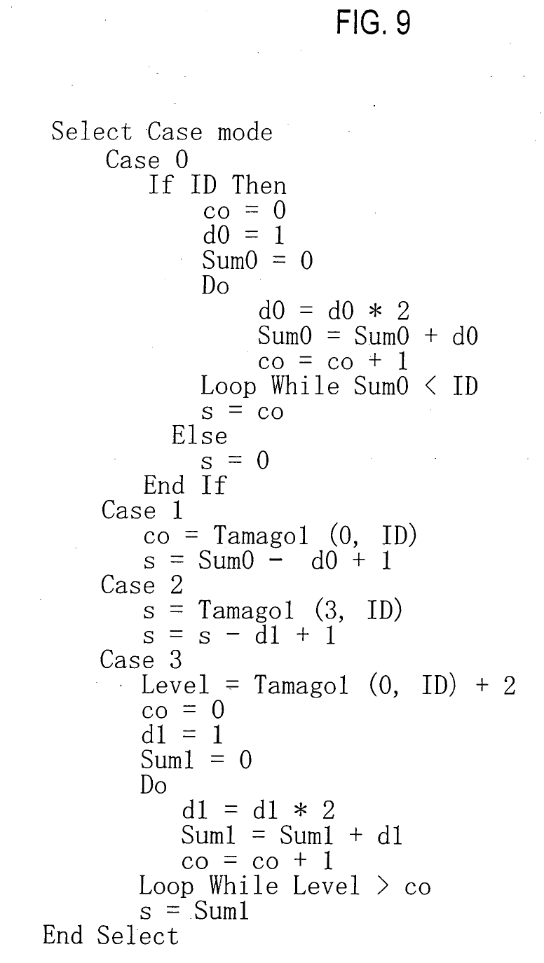

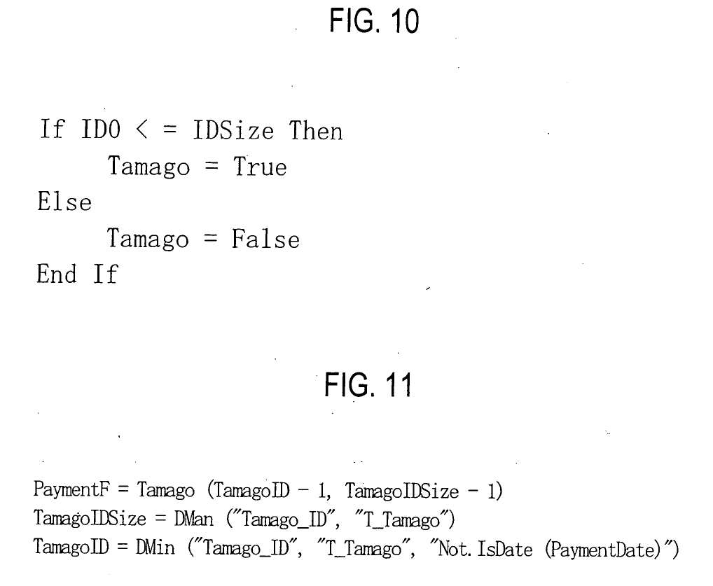

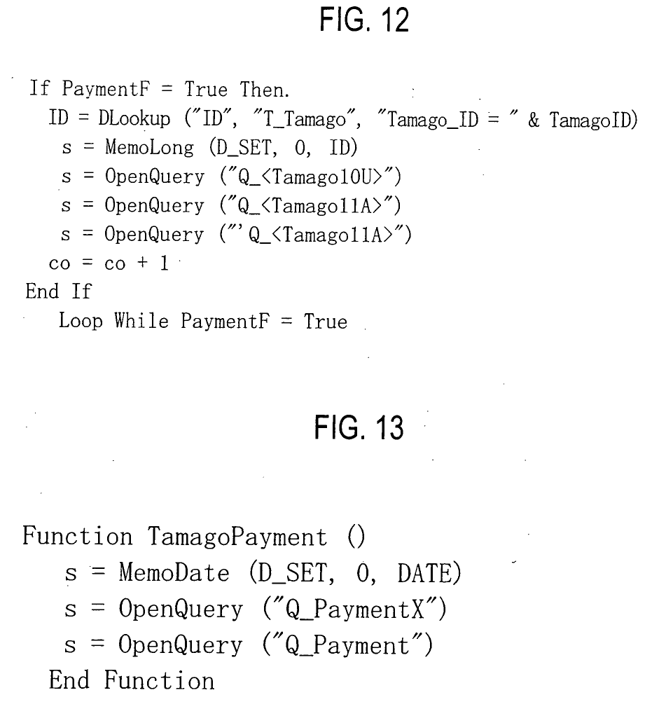

### Description of Symbols; and

FIG. 13 is a diagram illustrating a program executing a process for paying a bonus according to the present embodiment.

### DESCRIPTION OF SYMBOLS

10 Business transaction management system
20 Management unit
21 Customer management section
22 Sales management section
23 Money receipt management section
24 Delivery management section
25 Bonus management section
26 Maintenance management section
30 Input/output controller
32 Internal storage
40 Input unit
41 Input means
42 External storage
50 Output unit
51 Display output section
52 Print output section
53 Display monitor
54 Printer
55 Data output section
61 “Customer management” button
62 “Bonus management” button
63 “Sales management” button
64 “Money receipt management” button
65 “Delivery management” button
66 “Maintenance management” button

1. A profit distribution system comprising:
an identification number for assigning means [A] assigning an identification number to each of customers to be registered as members in connection with purchase of a predetermined commodity as a part of information about the members in order of registration;
a member positioning means [B] for associating and positioning two members with each member as members at the next level below the member;
a group forming means [C] for forming one group having first to n^{th} levels (where n is a natural number) and comprising a quorum of 2ⁿ−1 members;
a point giving means [D] for giving a predetermined point to a member at the first level of the group as a right to receive a bonus when 2ⁿ−1 members belong to the group and the quorum has been reached;
a group updating means [E] for, when a point is given by the point giving means, canceling the location of the member at the first level and dividing the group to which the member at the first level has belonged into two to form two new groups, each having as the member at the top level a member that has been at the second level of the group to which the member at the first level has belonged; and
a bonus determining means [F] for determining a bonus to be paid to a member according to a point given by the point giving means.

2. The profit distribution system according to claim 1, wherein said group updating means assigns two identification numbers to the member whose location at the first level has been canceled and repositions the member in two locations next to the last registered member.

3. A profit distribution method comprising:
an identification number step of assigning an identification number to each of customers to be registered as members in connection with purchase of a predetermined commodity as a part of information about the members in order of registration;
a member positioning step of associating and positioning two members with each member as members at the next level below the member;
a group forming step of forming one group having first to n^{th} levels (where n is a natural number) and comprising a quorum of 2ⁿ−1 members;
a point giving step of giving a predetermined point to a member at the first level of the group as a right to receive a bonus when 2ⁿ−1 members belong to the group and the quorum has been reached;
a group updating step of, after a point is given by the point giving means, canceling the location of the member at the first level and dividing the group to which the member at the first level has belonged into two to form two new groups, each having as the member at the top level a member that has been at the second level of the group to which the member at the first level has belonged;
a bonus determining step of determining a bonus to be paid to a member according to a point given by the point giving means; and
a payment indicating step of indicating that a bonus determined in the bonus determining step is to be paid.

4. The profit distribution method according to claim 3, wherein said group updating step assigns two identification numbers to the member whose location at the first level has been canceled and repositions the member in two locations next to the last registered member.
